(19) United States
(12) Patent Application Publication
(10) Pub. No.: US 2008/0088557 A1
(43) Pub. Date: Apr. 17, 2008

(54) DISPLAY APPARATUS AND CONTROL METHOD THEREOF

(75) Inventor: Hoon CHOI, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/762,995

(22) Filed: Jun. 14, 2007

(30) Foreign Application Priority Data
Oct. 16, 2006 (KR) 10-2006-0100328

(51) Int. Cl. G09G 3/36

(52) U.S. Cl. 345/88

(57) ABSTRACT

A display apparatus, includes: a plurality of light emitting elements which emits light of colors respectively; a light sensing part which senses a spectrum emitted from the light emitting elements; a diffusing part which mixes light emitted from the light emitting elements to form a white light; and a control part which plurally changes and outputs predetermined driving values which make the light emitting elements emit light, receives a measured value from a light measuring device which measures the white light formed by the diffusing part whenever the predetermined driving values are changed, calculates tristimulus values out of the received measured value, and calculates a transformation matrix coefficient transformed out of the tristimulus values and a sensing value of the light sensing part.

### CROSS-REFERENCE TO RELATED APPLICATIONS

This application claims priority from Korean Patent Application No. 10-2006-0100328, filed on Oct. 16, 2006, in the Korean Intellectual Property Office, the disclosure of which is incorporated herein by reference.

### BACKGROUND OF INVENTION

1. Field of Invention

Apparatuses and methods consistent with the present invention relate to a display and controlling a color coordinate of light emitting elements depending on temperature.

2. Description of the Related Art

Recently, as a display apparatus having a liquid crystal display (LCD) panel has been widely used, a light emitting element has been extendedly used as a light source for color reproducibility and enlargement of the liquid crystal display panel. Generally, a color expression area becomes extended by using a plurality of light emitting elements emitting light of colors. However, the efficiency of each light emitting element with respect to temperature differs, and a wavelength of light of the light emitting element varies depending on temperature.

To solve the problem, the U.S. Pat. No. 6,411,046 discloses a control method using a light sensor and a temperature sensor to control light emitting elements.

However, in the U.S. Pat. No. 6,411,046, a conversion relation connecting a detected value of a light sensor and the brightness of light emitting elements is not clearly disclosed. Since a spectrum property of the light sensor does not correctly identify a spectrum of each light emitting element, although the brightness of the light emitting element is determined, the detected value of the light sensor is not determined. Also, the U.S. Pat. No. 6,411,046 is for the case if the spectrum of the light emitting element is fixed. If the spectrum varies depending on a temperature variation, an output of the sensor can not be obtained only from the value about the brightness of each light emitting element depending on temperature, and it is not easy to complete a practical embodiment. Also, although a color coordinate control is precisely conducted in the light emitting element part, a color coordinate of a white light penetrating a liquid crystal display and a filter thereof varies. Accordingly, it is necessary to compensate for the variation.

### SUMMARY OF THE INVENTION

Accordingly, it is an aspect of the present invention to provide a display apparatus and a control method thereof precisely controlling a color coordinate of light emitting elements depending on temperature.

Another aspect of the present invention is to provide a display apparatus and a control method thereof compensating for a color coordinate which is variable depending on a property of a liquid crystal display panel.

Additional aspects of the present invention will be set forth in part in the description which follows and, in part, will be obvious from the description, or may be learned by practice of the present invention.

The foregoing and/or other aspects of the present invention can be achieved by providing a display apparatus, comprising: a plurality of light emitting elements which emits light of colors respectively; a light sensing part which senses a spectrum emitted from the light emitting elements; a diffusing part which mixes light emitted from the light emitting elements to form a white light; and a control part which plurally changes and outputs predetermined driving values which make the light emitting elements emit light, receives a measured value from a light measuring device which measures the white light formed by the diffusing part whenever the predetermined driving values are changed, calculates tristimulus values out of the received measured value, and calculates a transformation matrix coefficient transformed out of the tristimulus values and a sensing value of the light sensing part.

According to the embodiment of the present invention, the display apparatus further comprises a light emitting element part which comprises the light emitting elements, and a temperature sensing part which senses the temperature of the light emitting element part, wherein the control part calculates a plurality of transformation matrix coefficients based on predetermined temperature values sensed by the temperature sensing part.

According to the embodiment of the present invention, with respect to a plurality of temperature intervals, the control part calculates an approximate transformation matrix coefficient for each temperature value by a linear approximation method by using the plurality of transformation matrix coefficients calculated based on the predetermined temperature values.

According to the embodiment of the present invention, with respect to a whole temperature interval, the control part calculates an approximate transformation matrix coefficient for each temperature value by an approximate function method of a polynomial by using the plurality of transformation matrix coefficients calculated based on the predetermined temperature values.

According to the embodiment of the present invention, the display apparatus further comprises a storing part, wherein the control part stores the transformation matrix coefficient and/or the approximate transformation matrix coefficient in the storing part.

According to the embodiment of the present invention, the control part calculates an objective sensing value of the light sensing part which corresponds to an objective tristimulus value, out of the transformation matrix coefficient and/or the approximate transformation matrix coefficient according to the temperature value.

According to the embodiment of the present invention, the display apparatus further comprises a storing part, wherein the control part stores the objective sensing value of the light sensing part calculated according to the temperature value in the storing part.

According to the embodiment of the present invention, the received measured value comprises a color coordinate (x, y) and a brightness information.

According to the embodiment of the present invention, the display apparatus further comprises a liquid crystal display panel, wherein the received measured value comprises a measured value of a white light which penetrated the liquid crystal display panel.

According to the embodiment of the present invention, the light emitting elements comprise a red light emitting element, a green light emitting element and a blue light emitting element.

According to the embodiment of the present invention, the control part changes three times and outputs predetermined driving values which make the red light emitting element, the green light emitting element and the blue light emitting element emit light.

According to the embodiment of the present invention, the control part drives the red light emitting element, the green light emitting element and the blue light emitting element respectively by a pulse width modulation.

The foregoing and/or other aspects of the present invention can be achieved by providing a display apparatus, comprising: a light emitting element part comprising a plurality of light emitting elements which emits light of colors respectively; a temperature sensing part which senses the temperature of the light emitting element part; a light sensing part which senses a spectrum emitted from the light emitting elements; a storing part which stores a transformation matrix coefficient and/or an approximate transformation matrix coefficient calculated by plurally changing predetermined driving values which make the light emitting elements emit light; and a control part which calculates an objective sensing value of the light sensing part, corresponding to an objective tristimulus value, out of the transformation matrix coefficient and/or the approximate transformation matrix coefficient stored in the storing part according to a temperature value of the temperature sensing part, and compares a sensing value of the light sensing part with the objective sensing value of the light sensing part to generate an error correcting control signal related to the light emitting elements.

According to the embodiment of the present invention, the storing part stores tristimulus values which are calculated out of an inputted color coordinate (x, y) and a brightness information, and a transformation matrix coefficient transformed out of the sensing values of the light sensing part.

According to the embodiment of the present invention, the control part adjusts and outputs a duty ratio of a pulse width modulation depending on the error correcting control signal to the light emitting elements.

The foregoing and/or other aspects of the present invention can be achieved by providing a control method of a display apparatus which comprises a light sensing part and a temperature sensing part, comprising: calculating a predetermined temperature value by the temperature sensing part; plurally changing and outputting predetermined driving values which make a plurality of light emitting elements emits light based on the predetermined temperature, and receiving a sensing value of the light sensing part, a color coordinate (x, y) and a brightness information whenever the predetermined driving values are changed; and calculating a transformation matrix coefficient transformed out of tristimulus values which are calculated out of the color coordinate (x, y) and the brightness information, and the sensing value of the light sensing part.

According to the embodiment of the present invention, the control method of the display apparatus further comprises calculating a plurality of transformation matrix coefficients based on predetermined temperature values sensed by the temperature sensing part.

According to the embodiment of the present invention, the control method of the display apparatus further comprises, with respect to a plurality of temperature intervals, calculating an approximate transformation matrix coefficient for each temperature value by a linear approximation method ity of temperature intervals by using the plurality of transformation matrix coefficients calculated based on the predetermined temperature values.

According to the embodiment of the present invention, the control method of the display apparatus further comprises, with respect to a whole temperature interval, calculating an approximate transformation matrix coefficient for each temperature value by an approximate function method of a polynomial using the plurality of transformation matrix coefficients calculated based on the predetermined temperature values.

According to the embodiment of the present invention, the control method of the display apparatus further comprises storing the transformation matrix coefficient and/or the approximate transformation matrix coefficient in a storing part.

According to the embodiment of the present invention, the control method of the display apparatus further comprises calculating an objective sensing value of the light sensing part with respect to an objective tristimulus value out of the transformation matrix coefficient and/or the approximate transformation matrix coefficient according to the temperature value.

According to the embodiment of the present invention, the control method of the display apparatus further comprises storing the objective sensing value of the light sensing part calculated according to the temperature value in a storing part.

The foregoing and/or other aspects of the present invention can be achieved by providing a control method of a display apparatus which comprises a light sensing part and a temperature sensing part, comprising: storing a transformation matrix coefficient and/or an approximate transformation matrix coefficient calculated by plurally changing predetermined driving values which make a plurality of light emitting elements emits light; calculating an objective sensing value of the light sensing part with respect to an objective tristimulus value out of the transformation matrix coefficient and/or the approximate transformation matrix coefficient according to a temperature value of the temperature sensing part; and comparing a sensing value of the light sensing part with the objective sensing value of the light sensing part to output an error correcting control signal related to the light emitting elements.

According to the embodiment of the present invention, the storing stage calculates tristimulus values out of an inputted color coordinate (x, y) and a brightness information, and stores a transformation matrix coefficient transformed out of the tristimulus values and the sensing values of the light sensing part.

### BRIEF DESCRIPTION OF THE DRAWINGS

The above and/or other aspects of the prevent invention will become apparent and more readily appreciated from the following description of the exemplary embodiments, taken in conjunction with the accompanying drawings, in which:

FIG. 1 is a block diagram illustrating a configuration of a display apparatus according to an exemplary embodiment of the present invention;

FIG. 2 is a flowchart illustrating a control method of the display apparatus according to an exemplary embodiment of the present invention;

FIG. 3 is a block diagram illustrating a configuration of a control part of a display apparatus according to an exemplary embodiment of the present invention; and

FIG. 4 is a flowchart illustrating a control method of the display apparatus according to an exemplary embodiment of the present invention

### DETAILED DESCRIPTION OF EXEMPLARY EMBODIMENTS OF THE INVENTION

Reference will now be made in detail to the embodiments of the present invention, examples of which are illustrated in the accompanying drawings, wherein like reference numerals refer to like elements throughout. The exemplary embodiments are described below so as to explain the present invention by referring to the figures.

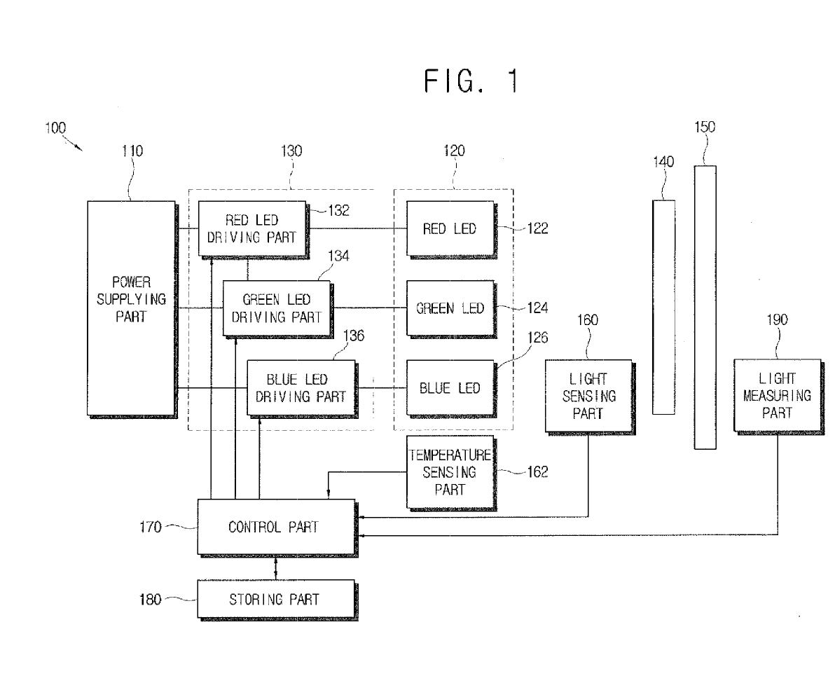

As shown in FIG. 1, a display apparatus 100 according to a first exemplary embodiment of the present invention comprises a power supplying part 110, a light emitting element part 120, a light emitting element driving part 130, a diffusing part 140, a liquid crystal display (LCD) panel 150, a light sensing part 160, a temperature sensing part 162, a control part 170 and a storing part 180.

To supply power to the light emitting element driving part 130, the power supplying part 110 converts an alternating current power to a direct current power needed by the light emitting element driving part 130, and supplies the power to the light emitting element driving part 130.

The light emitting element part 120 supplies light to the LCD panel 150. The light emitting element part 120 comprises a backlight unit in case of a liquid crystal display apparatus. The light emitting element part 120 includes a plurality of light emitting elements, which emits lights of colors, respectively, properly connected together in series or in parallel. The light emitting elements respond to a driving signal to generate a white light, and may comprise a red light emitting diode (LED) 122, a green LED 124 and a blue LED 126. Referring to FIG. 1, the light emitting elements comprise the red LED 122, the green LED 124 and the blue LED 126. Alternatively, the light emitting elements may comprise combination of other colored LEDs.

The light emitting element driving part 130 includes a red LED driving part 132, a green LED driving part 134 and a blue LED driving part 136 to supply power to the light emitting elements, the red LED 122, the green LED 124 and the blue LED 126. The light emitting element driving part 130 may control the light emitting elements by means of a pulse width modulation (PWM) to fix a peak current, thereby fixing an LED spectrum.

The diffusing part 140 diffuses light of the light emitting elements to generate a white light. That is, the diffusing part 140 mixes light outputs of the red LED 122, the green LED 124 and the blue LED 126 to form the white light.

The LCD panel 150 is a panel displaying an image. If a voltage is supplied to a liquid crystal, an arrangement of the liquid crystal changes. Here, light penetrates the liquid crystal to be diffracted, and the diffracted light penetrates a polarizing plate to display a desired image.

The light sensing part 160 includes light sensors sensing a spectrum emitted from the light emitting elements. That is, the light sensing pat 160 may include three filter-mounted light sensors of a red light sensor, a green light sensor and a blue light sensor, and an amplifier and a signal converting circuit needed for converting an output of the light sensors to an electric signal which is capable of being used by the control part 170. The light sensors may be disposed outside or inside the diffusing part 140 to sufficiently sense the white light, and may be shielded so it is not affected by environmental light.

The temperature sensing part 162 senses the temperature of the light emitting element part 120. A temperature information sensed by the temperature sensing part 162 is inputted to the control part 170. The control part 170 uses the inputted temperature information to calculate a temperature value of the light emitting element part 120, and outputs a control signal to the light emitting element driving part 130 based on the calculated temperature value to drive the light emitting elements.

A light measuring device 190 measures the white light formed by the diffusing part 140. Also, the white light which penetrated the LCD panel 150 may be measured to consider a filter property according to the temperature of the LCD and a spectrum transition property of the light emitting elements together. The value measured and outputted by the light measuring device 190 comprises a color coordinate (x, y) and a brightness information, and is inputted to the control part 170.

The control part 170 calculates a tristimulus value based on the measured value inputted from the light measuring device 190. Also, the control part 170 calculates a transformation matrix coefficient by using the sensed value inputted from the light sensing part 160 and the calculated tristimulus value.

The control part 170 calculates a plurality of transformation matrix coefficients based on predetermined temperature values sensed by the temperature sensing part 162. Also, the control part 170 calculates an approximate transformation matrix coefficient according to each temperature value for a plurality of temperature intervals by means of a linear approximation method by using a plurality of transformation matrix coefficients calculated based on the predetermined temperature values, or calculates an approximate transformation matrix coefficient according to each temperature value for a whole temperature interval by means of an approximate function method of a polynomial by using the plurality of transformation matrix coefficients calculated based on the predetermined temperature values.

The control part 170 calculates an objective sensing value of the light sensing part 160 corresponding to an objective tristimulus value out of the transformation matrix coefficient and/or the approximate matrix data according to each temperature value.

The storing part 180 stores the transformation matrix coefficient and/or the approximate matrix data to be used for obtaining an objective color coordinate. Also, the storing part 180 stores the objective sensing values Rt, Gt and Bt of the light sensing part 160 about a specific color coordinate calculated according to the temperature value. Referring to FIG. 1, the storing part 180 is separately provided from the control part 170. Alternatively, the storing part 180 may be included in the control part 170.

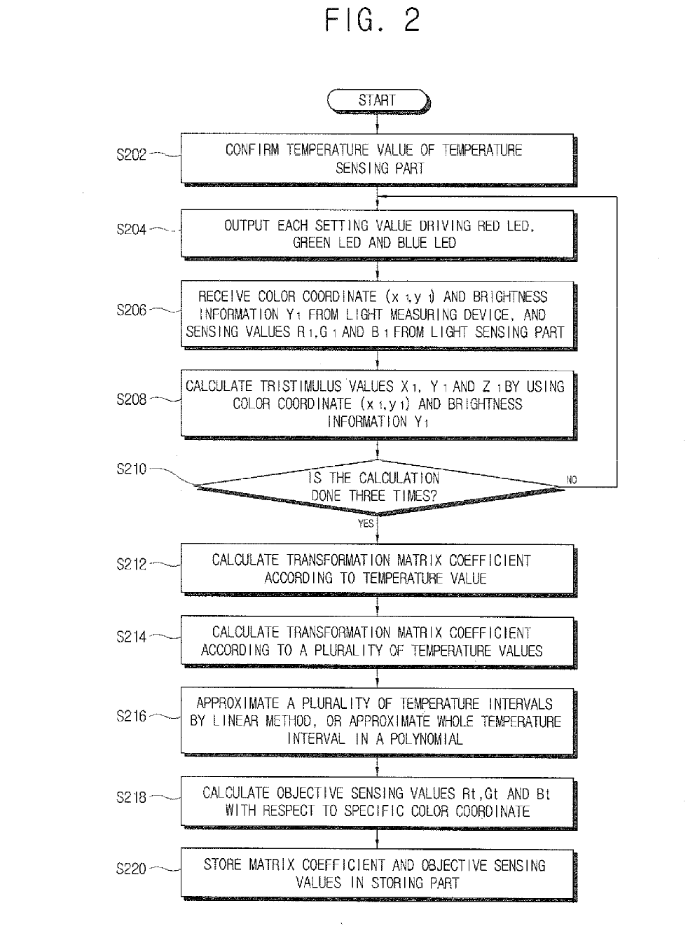

FIG. 2 is a flowchart illustrating a control method of the display apparatus according to the first exemplary embodiment of the present invention. The present invention is explained in more detail according to the flow chart in FIG. 2

At first, a calculating method of tristimulus values X, Y and Z by using a color coordinate (x, y) and a brightness information Y inputted from the light measuring device 190 is given in the following Equations 1 and 2.

X=x/y×Y EQN. [1]

Z=(1−x−y)/y×y EQN. [2]

Following Equation 3 is obtained by using the tristimulus values X, Y and Z calculated by means of Equations 1 and 2, and sensed values R, G and B of the light sensing part 160.

$$[ \begin{matrix}R \\ G \\ B\end{matrix} ] = [ \begin{matrix}m 11 & m 12 & m 13 \\ m 21 & m 22 & m 23 \\ m 31 & m 32 & m 33\end{matrix} ] [ \begin{matrix}X \\ Y \\ Z\end{matrix} ] \qquad EQN . [ 3 ]$$

Hereinafter, a control method allowing a color coordinate to be uniformly outputted on the diffusing part 140 without using the LCD panel 150 shown in FIG. 1 will be described.

Temperature sensed by the temperature sensing part 162 is determined whether it is a predetermined temperature or not (S202). For example, a sensed temperature is 25° C.

Then, at 25° C., to drive the red LED 122, the green LED 124 and the blue LED 126 of the light emitting element part 120, for example, the control part 170 supplies a control signal corresponding to a setting value (2000, 4000, 4000) to the red LED driving part 132, the green LED driving part 134 and the blue LED driving part 136 of the light emitting element driving part 130. The light emitting element driving part 130 adjusts a duty ratio of the PWM depending on the control signal to drive the red LED 122, the green LED 124 and the blue LED 126 (S204) with corresponding driving currents.

Then, the measured value of a color coordinate (x1, y1) and a brightness information Y1 are received from the light measuring part 190, and the sensed values of R1, G1 and B1 are received from the light measuring device 190 (S206). Then, tristimulus values X1, Y1 and Z1 are calculated from the color coordinate (x1, y1) and the brightness information Y1 by using Equations 1 and 2 (S208).

It is determined whether the calculated tristimulus values and the sensed values of the light sensing part 160 have been calculated three times (S210).

If the calculated tristimulus values and the sensed values of the light sensing part 160 have not been calculated three times, the control part 170 outputs a setting value (4000, 2000, 4000) to the light emitting element driving part 130 to drive the red LED 122, the green LED 124 and the blue LED 126, respectively. Then, a color coordinate (x2, y2) and a brightness information Y2 are read from the light measuring device 190, tristimulus values X2, Y2 and Z2 are calculated from the measured values, and sensed values R2, G2 and B2 of the light sensing part 160 are read.

Finally, the control part 170 outputs a setting value (4000, 4000, 2000) to the light emitting element driving part 130 to drive the red LED 122, the green LED 124 and the blue LED 126 respectively. Then, a color coordinate (x3, y3) and a brightness information Y3 are read from the light measuring device 190, tristimulus values X3, Y3 and Z3 are calculated from the measured values, and sensed values R3, G3 and B3 of the light sensing part 160 are read.

If the calculated tristimulus values and the sensed values of the light sensing part 160 are calculated three times, following Equation 4 is obtained by using the calculated tristimulus values and the sensed values of the light sensing part 160 at 25° C.

$$[ \begin{matrix}R 1 & R 2 & R 2 \\ G 1 & G 2 & G 2 \\ B 1 & B 2 & B 2\end{matrix} ] = [ \begin{matrix}m 11 & m 12 & m 13 \\ m 21 & m 22 & m 23 \\ m 31 & m 32 & m 33\end{matrix} ] [ \begin{matrix}X 1 & X 2 & X 2 \\ Y 1 & Y 2 & Y 2 \\ Z 1 & Z 2 & Z 2\end{matrix} ] \qquad EQN . [ 4 ]$$

According to Equation 4, a transformation matrix coefficient at 25° C. is calculated as following Equation 5 (S212).

$$[ \begin{matrix}m 11 & m 12 & m 13 \\ m 21 & m 22 & m 23 \\ m 31 & m 32 & m 33\end{matrix} ] = {[ \begin{matrix}R 1 & R 2 & R 2 \\ G 1 & G 2 & G 2 \\ B 1 & B 2 & B 2\end{matrix} ] [ \begin{matrix}X 1 & X 2 & X 2 \\ Y 1 & Y 2 & Y 2 \\ Z 1 & Z 2 & Z 2\end{matrix} ]}^{- 1} \qquad EQN . [ 5 ]$$

Then, by the above process, transformation matrix coefficients at 40° C. and at 70° C. are calculated (S214).

The calculated transformation matrix coefficients have different entries according to temperature. The transformation matrix coefficient at 25° C. calculated by using Equation 5 is as follows:

$$[ \begin{matrix}5.532125734 & - 1.431165459 & - 0.985143692 \\ - 0.992379839 & 7.400852704 & 0.259601137 \\ - 0.059331587 & 0.473598619 & 1.86409093\end{matrix} ]$$

The transformation matrix coefficient at 40° C. calculated by using Equation 5 is as follows:

$$[ \begin{matrix}5.956908171 & - 1.669843426 & - 1.065118099 \\ - 1.018345766 & 7.527862043 & 0.268015642 \\ - 0.066715416 & 0.493589223 & 1.833890576\end{matrix} ]$$

The transformation matrix coefficient at 70° C. calculated by using Equation 5 is as follows:

$$[ \begin{matrix}6.410641602 & - 1.897869236 & - 1.091503825 \\ - 2.800956807 & 6.176787096 & 0.347873323 \\ - 0.18443796 & 0.407495077 & 1.862335515\end{matrix} ]$$

With respect to an interval between the temperatures, that is, an interval between 25° C. and 40° C., and an interval between 40° C. and 70° C., the control part 170 may calculate the approximate transformation matrix coefficient for each temperature value by the linear approximation method using the transformation matrix coefficient. Also, with respect to a whole temperature interval, that is, an interval between 25° C. and 70° C., the control part 170 may calculate the approximate transformation matrix coefficient for each temperature value by the approximate function method of a polynomial using the transformation matrix coefficient (S216).

The case above is available in targeting various color coordinates. If the color coordinate is determined to be a specific value, the objective sensing values Rt, Gt and Bt of the light sensing part 160 for the color coordinate can be directly calculated by using the transformation matrix coefficient and/or the approximate transformation matrix coefficient, thereby reducing the amount of calculation to one third without calculating a separate matrix coefficient (S218).

The control part 170 stores the calculated transformation matrix coefficient and/or the approximate transformation matrix coefficient, and the objective sensing values Rt, Gt and Bt of the light sensing part 160 in the storing part 180 (S220).

Although a color coordinate control on the light emitting element part 120 is precisely accomplished, there happens a color coordinate variation of light which penetrated the LCD panel 150. Accordingly, if a filter property according to the temperature of the LCD panel 150 and a spectrum transition property of each light emitting element are intended to be considered together, a color coordinate (x, y) and a brightness information may be measured by the light measuring device 190 in the state when the LCD panel 150 is placed on the light emitting element part 120.

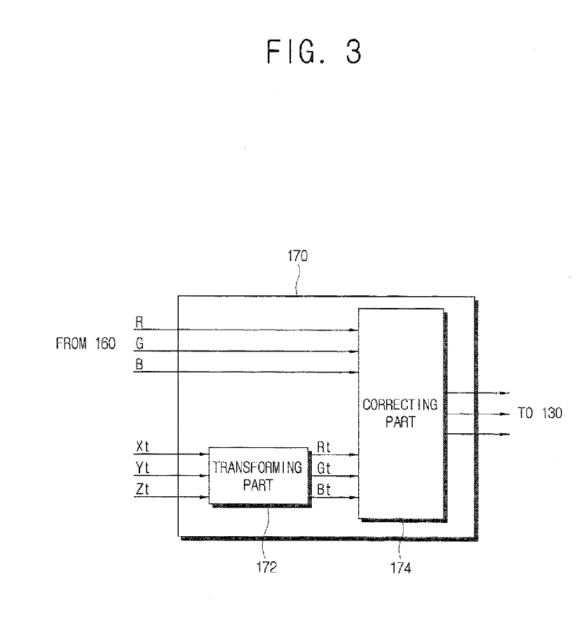

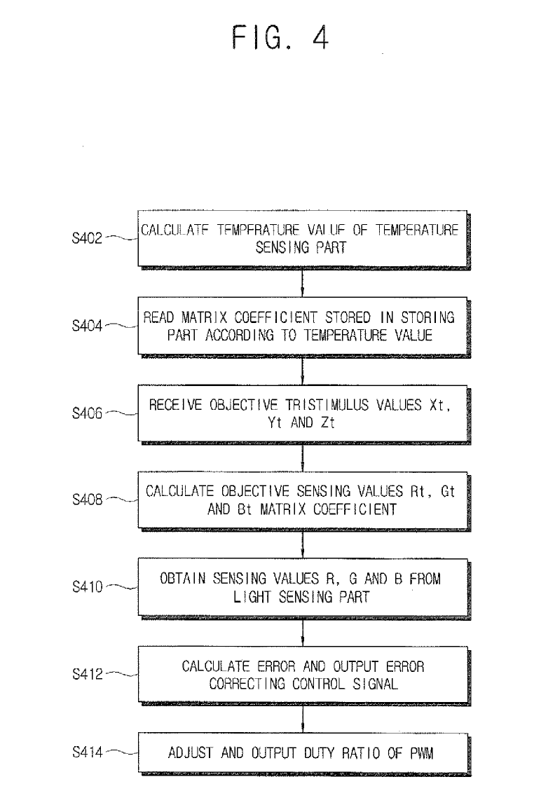

FIG. 3 is a block diagram illustrating a configuration of a control part of a display apparatus according to a second exemplary embodiment of the present invention, and FIG. 4 is a flowchart illustrating a control method of the display apparatus according to the second exemplary embodiment of the present invention. FIGS. 3 and 4 illustrate a method of driving light emitting elements by using a transformation matrix coefficient and/or an approximate transformation matrix coefficient calculated according to FIG. 2 and stored in a storing part 180.

A control part 170 calculates a temperature value by using a temperature information sensed by a temperature sensing part 162 (S402). Then, the control part 170 reads a transformation matrix coefficient or an approximate transformation matrix coefficient stored in a storing part 180 according to the temperature value, and stores it in a transforming part 172 (S404).

Objective tristimulus values Xt, Yt and Zt are inputted to the transforming part 172 through a user input part or by a program (S406). The control part 170 calculates objective sensing values Rt, Gt and Bt by using the objective tristimulus values Xt, Yt and Zt, and the transformation matrix coefficient or the approximate transformation matrix coefficient stored in the transforming part 171 (S408).

The control part 170 obtains sensing values R, G and B sensed by a light sensing part 160 (S410). Then, a correcting part 174 compares the sensing values R, G and B with the objective sensing values Rt, Gt and Bt to calculate an error, and outputs an error correcting control signal to a light emitting element driving part 130 to correct the error (S412). The light emitting element driving part 130 adjusts and outputs a duty ratio of a PWM depending on the error correcting control signal to control the amount of light of light emitting elements (S414). As described above, the present invention provides a display apparatus and a control method thereof precisely controlling a color coordinate of light emitting elements depending on temperature.

Also, the present invention provides a display apparatus and a control method thereof compensating for a color coordinate which is variable depending on a property of a liquid crystal display panel.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display apparatus, comprising:
a plurality of light emitting elements which emit lights of colors, respectively;
a light sensing part which senses a spectrum emitted from the plurality of light emitting elements;
a diffusing part which mixes the lights emitted from the plurality of light emitting elements to form a white light; and
a control part which changes and outputs predetermined driving currents for the plurality of light emitting elements, receives a measured value from a light measuring device which measures the white light formed by the diffusing part when the predetermined driving currents are changed, calculates tristimulus values from the received measured value, and calculates a transformation matrix coefficient transformed from the tristimulus values and a sensing value of the light sensing part.

2. The display apparatus according to claim 1, further comprising a light emitting element part which comprises the plurality of light emitting elements, and a temperature sensing part which senses a temperature of the light emitting element part,
wherein the control part calculates a plurality of transformation matrix coefficients based on predetermined temperature values sensed by the temperature sensing part.

3. The display apparatus according to claim 2, wherein, with respect to a plurality of temperature intervals, the control part calculates an approximate transformation matrix coefficient for each temperature value by a linear approximation method by using the plurality of transformation matrix coefficients calculated based on the predetermined temperature values.

4. The display apparatus according to claim 2, wherein, with respect to a temperature interval, the control part calculates an approximate transformation matrix coefficient for each temperature value by an approximate function method of a polynomial by using the plurality of transformation matrix coefficients calculated based on the predetermined temperature values.

5. The display apparatus according to claim 3, further comprising a storing part,
wherein the control part stores at least one of the transformation matrix coefficient and the approximate transformation matrix coefficient in the storing part.

6. The display apparatus according to claim 3, wherein the control part calculates an objective sensing value of the light sensing part which corresponds to an objective tristimulus value, from at least one of the transformation matrix coefficient and the approximate transformation matrix coefficient according to the temperature value.

7. The display apparatus according to claim 6, further comprising a storing part,
wherein the control part stores the objective sensing value of the light sensing part calculated according to the temperature value in the storing part.

8. The display apparatus according to claim 1, wherein the received measured value comprises a color coordinate (x, y) and a brightness information.

9. The display apparatus according to claim 8, further comprising a liquid crystal display panel,
wherein the received measured value comprises a measured value of a white light which penetrated the liquid crystal display panel.

10. The display device according to claim 1, wherein the plurality of light emitting elements comprise a red light emitting element, a green light emitting element and a blue light emitting element.

11. The display apparatus according to claim 10, wherein the control part changes predetermined driving currents for the red light emitting element, the green light emitting element and the blue light emitting element three times and outputs the predetermined driving currents for the red light emitting element, the green light emitting element and the blue light emitting element.

12. The display apparatus according to claim 10, wherein the control part drives the red light emitting element, the green light emitting element and the blue light emitting element by a pulse width modulation.

13. A display apparatus, comprising:
a light emitting element part comprising a plurality of light emitting elements which emit lights of colors, respectively;
a temperature sensing part which senses a temperature of the light emitting element part;
a light sensing part which senses a spectrum emitted from the plurality of light emitting elements;
a storing part which stores at least one of a transformation matrix coefficient and an approximate transformation matrix coefficient calculated by changing predetermined driving currents of the plurality of light emitting elements; and
a control part which calculates an objective sensing value of the light sensing part, corresponding to an objective tristimulus value, from at least one of the transformation matrix coefficient and the approximate transformation matrix coefficient stored in the storing part according to a temperature value of the temperature sensing part, and compares a sensing value of the light sensing part with the objective sensing value of the light sensing part to generate an error correcting control signal for the plurality of light emitting elements.

14. The display apparatus according to claim 13, wherein the storing part stores tristimulus values which are calculated from an inputted color coordinate (x, y) and a brightness information, and a transformation matrix coefficient transformed from the sensing values of the light sensing part.

15. The display apparatus according to claim 13, wherein the control part adjusts and outputs a duty ratio of a pulse width modulation depending on the error correcting control signal to the plurality of light emitting elements.

16. A control method of a display apparatus having a light sensing part and a temperature sensing part, the control method comprising:
calculating a predetermined temperature value by the temperature sensing part;
changing and outputting predetermined driving currents of a plurality of light emitting elements based on the predetermined temperature, and receiving a sensing value of the light sensing part, a color coordinate (x, y) and a brightness information when the predetermined driving currents are changed; and
calculating a transformation matrix coefficient transformed from tristimulus values which are calculated from the color coordinate (x, y) and the brightness information, and the sensing value of the light sensing part.

17. The control method of the display apparatus according to claim 16, further comprising calculating a plurality of transformation matrix coefficients based on predetermined temperature values sensed by the temperature sensing part.

18. The control method of the display apparatus according to claim 17, further comprising, with respect to a plurality of temperature intervals, calculating an approximate transformation matrix coefficient for each temperature value by a linear approximation method ity of temperature intervals by using the plurality of transformation matrix coefficients calculated based on the predetermined temperature values.

19. The control method of the display apparatus according to claim 17, further comprising, with respect to a temperature interval, calculating an approximate transformation matrix coefficient for each temperature value by an approximate function method of a polynomial using the plurality of transformation matrix coefficients calculated based on the predetermined temperature values.

20. The control method of the display apparatus according to claim 18, further comprising storing at least one of the transformation matrix coefficient and the approximate transformation matrix coefficient in a storing part.

21. The control method of the display apparatus according to claim 18, further comprising calculating an objective sensing value of the light sensing part with respect to an objective tristimulus value from at least one of the transformation matrix coefficient and the approximate transformation matrix coefficient according to the temperature value.

22. The control method of the display apparatus according to claim 21, further comprising storing the objective sensing value of the light sensing part calculated according to the temperature value in a storing part.

23. A control method of a display apparatus including a light sensing part and a temperature sensing part, the control method comprising:
storing at least one of a transformation matrix coefficient and an approximate transformation matrix coefficient calculated by changing predetermined driving currents of a plurality of light emitting elements;
calculating an objective sensing value of the light sensing part with respect to an objective tristimulus value from the transformation matrix coefficient and/or the approximate transformation matrix coefficient according to a temperature value of the temperature sensing part; and
comparing a sensing value of the light sensing part with the objective sensing value of the light sensing part to output an error correcting control signal for the plurality of light emitting elements.

24. The control method of the display apparatus according to claim 23, wherein the storing stage calculates tristimulus values from an inputted color coordinate (x, y) and a brightness information, and stores a transformation matrix coefficient transformed out of the tristimulus values and the sensing values of the light sensing part.
